(19) United States
(12) Patent Application Publication
(10) Pub. No.: US 2026/0328617 A1
(43) Pub. Date: Oct. 22, 2026

(54) OPTICAL DEVICE AND OPTICAL SYSTEM

(71) Applicant: CANON KABUSHIKI KAISHA, Tokyo (JP)

(72) Inventors: KENJI MATSUDA, Kanagawa (JP); MASATSUGU KOYAMA, Kanagawa (JP)

(21) Appl. No.: 19/529,497

(22) Filed: Feb. 4, 2026

(30) Foreign Application Priority Data
Feb. 28, 2025 (JP) 2025-031411

(51) Int. Cl. G01J 3/02; G01J 3/28; H04N 23/12; H04N 23/957

(52) U.S. Cl. CPC G01J 3/021; G01J 3/0229; G01J 3/2823; H04N 23/12; H04N 23/957

(57) ABSTRACT

An optical device includes a first light receiving portion having a first reflecting surface group, a second light receiving portion having a second reflecting surface group, and a support that supports the first light receiving portion and the second light receiving portion. With respect to a first virtual plane perpendicular to an optical axis of the optical device and intersecting the support, the first light receiving portion has, separately from the first reflecting surface group, an incident surface on which light incident through the first virtual plane is incident, and has a structure configured such that at least a part of the light incident on the incident surface is reflected and is incident on a portion of the support.

### BACKGROUND

### Field of the Invention

The present disclosure relates to an optical device that can be used in various fields such as astronomical observation and material analysis.

### Description of the Related Art

Conventionally, in various fields such as astronomical observation and material analysis, optical devices have been used that spectrally disperse light according to wavelength, receive the light with a detector, and measure intensity. In the field of astronomical observation, an observation technique called integral field spectroscopy is known that simultaneously observes two-dimensional spatial information and spectral information. As optical systems used to realize integral field spectroscopy, a microlens array type, a fiber bundle type, an image slicer type, and the like are known.

Although the configuration of the optical system of the image slicer type is not simple, it is known to have little loss of spatial information and to have high spatial resolution even in a narrow field of view. In the image slicer type, a slice mirror, a pupil mirror, and the like are combined to constitute an integral field spectroscopy system. The slice mirror is a mirror that divides a focal plane image of a telescope into a plurality of elongated images. The pupil mirror is a mirror for rearranging the images divided by the slice mirror in one dimension.

In an image slicer type optical device, observation light incident on the slice mirror is reflected in mutually different directions as a plurality of light beams that have been divided by a plurality of reflecting surfaces included in the slice mirror. Each of the plurality of light beams is guided to different light receiving regions of a photosensor via the pupil mirror and the like.

Japanese Patent Laid-Open No. 2022-96461 describes an optical device including a slice mirror. FIG. 12A is a plan view of the slice mirror described in Japanese Patent Laid-Open No. 2022-96461, and FIG. 12B is a perspective view thereof. The slice mirror includes a plurality of rectangular reflecting surfaces 2a. In order to divide incident observation light and reflect the divided light in different directions, each of the reflecting surfaces 2a included in the slice mirror faces a mutually different direction.

The present inventors considered improving spatial or frequency-related resolution in integral field spectroscopy in an integral field spectroscopy system using an image slicer type optical device.

In this context, the present inventor found that there is room for improvement in optical characteristics of the optical device.

### SUMMARY

According to a first aspect of the present disclosure, an optical device includes a first light receiving portion having a first reflecting surface group, a second light receiving portion having a second reflecting surface group, and a support that supports the first light receiving portion and the second light receiving portion. With respect to a first virtual plane perpendicular to an optical axis of the optical device and intersecting the support, a second virtual plane perpendicular to the optical axis and intersecting the support, and a third virtual plane perpendicular to the optical axis and between the first virtual plane and the second virtual plane, the first light receiving portion is positioned between the third virtual plane and the second virtual plane, and the second light receiving portion is positioned between the first virtual plane and the third virtual plane. The first reflecting surface group is configured to reflect light incident through the first virtual plane in a plurality of different directions non-parallel to the optical axis, the second reflecting surface group is configured to reflect the light reflected by the first reflecting surface group, and the light reflected by the second reflecting surface group is emitted through the second virtual plane. The first light receiving portion has, separately from the first reflecting surface group, an incident surface on which light incident through the first virtual plane is incident, and the first light receiving portion has a structure configured such that at least a part of light incident on the incident surface is not emitted through the second virtual plane.

According to a second aspect of the present disclosure, an optical device includes a first light receiving portion having a first reflecting surface group, a second light receiving portion having a second reflecting surface group, and a support that supports the first light receiving portion and the second light receiving portion. With respect to a first virtual plane perpendicular to an optical axis of the optical device and intersecting the support, a second virtual plane perpendicular to the optical axis and intersecting the support, and a third virtual plane perpendicular to the optical axis and between the first virtual plane and the second virtual plane, the first light receiving portion is positioned between the third virtual plane and the second virtual plane, and the second light receiving portion is positioned between the first virtual plane and the third virtual plane. The first reflecting surface group is configured to reflect light incident through the first virtual plane in a plurality of different directions non-parallel to the optical axis, the second reflecting surface group is configured to reflect the light reflected by the first reflecting surface group, and the light reflected by the second reflecting surface group is emitted through the second virtual plane. The first light receiving portion has, separately from the first reflecting surface group, an incident surface on which light incident through the first virtual plane is incident, and has a structure configured such that at least a part of the light incident on the incident surface is reflected at the incident surface and is incident on a portion of the support located between the second virtual plane and the third virtual plane.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram for explaining an overall configuration of an optical system according to a first embodiment.

FIG. 2A is a schematic cross-sectional view of the integral field spectroscopy unit 21 taken along the YZ plane.

FIG. 2B is an enlarged view of a portion surrounded by a dotted line A1 in FIG. 2A.

FIG. 3 is an exploded perspective view for explaining a structure of the integral field spectroscopy unit.

FIG. 4 is a plan view of the incident side member 2 as viewed along the Z plus direction from the emission side member 4 side.

FIG. 5A is a plan view of the emission side member 4 as viewed along the Z minus direction from the incident side member side.

FIG. 5B is an enlarged plan view showing the slice mirror 1 in an enlarged manner.

FIG. 6 is a perspective view showing the integral field spectroscopy unit 21 with the incident side member 2 removed to make an inner surface of the intermediate member 3 easily visible.

FIG. 7 is a schematic cross-sectional view showing the integral field spectroscopy unit 21 as an example of a second embodiment.

FIG. 8A is a perspective view showing an appearance of the emission side member 4A according to a third embodiment.

FIG. 8B is an exploded perspective view of the emission side member 4A according to the third embodiment.

FIG. 9 is a perspective view of the emission side member 4C according to a fourth embodiment.

FIG. 10A is a front view of the emission side member 4C according to the fourth embodiment.

FIG. 10B is an enlarged view of a region A2 surrounded by a dotted line in FIG. 10A.

FIG. 11A is a schematic cross-sectional view of the integral field spectroscopy unit 21C according to the fourth embodiment taken along the YZ plane.

FIG. 11B is an enlarged view of a portion A3 surrounded by a dotted line in FIG. 11A.

FIG. 12A is a plan view of a slice mirror.

FIG. 12B is a perspective view of the slice mirror.

FIG. 13 is a diagram illustrating a configuration of the integral field spectroscopy unit.

### DESCRIPTION OF THE EMBODIMENTS

Optical components, optical systems, optical devices, and the like according to embodiments of the present disclosure will be described with reference to the drawings. The embodiments shown below are illustrative, and for example, detailed configurations can be appropriately modified and implemented by those skilled in the art within a range not departing from the spirit of the present disclosure.

In the drawings referred to in the description of the following embodiments, elements denoted by the same reference numerals have similar functions unless otherwise noted. In the drawings, when a plurality of identical elements are arranged, the assignment of reference numerals and the description thereof may be omitted.

In addition, since drawings may be schematically expressed for convenience of illustration and description, shapes, sizes, arrangements, and the like of elements described in the drawings may not strictly match actual objects. Descriptions such as “XX or more and YY or less” and “XX to YY” representing numerical ranges mean numerical ranges including XX (lower limit) and YY (upper limit) as end points unless otherwise specified. When numerical ranges are described in stages, upper limits and lower limits of the respective numerical ranges can be arbitrarily combined.

In the following description, in order to clarify positional relationships, an X-axis direction, a Y-axis direction, and a Z-axis direction that are orthogonal to each other are defined. For example, when described as X plus direction, it refers to the same direction as that indicated by the X-axis arrow in the illustrated orthogonal coordinate system, and when described as X minus direction, it refers to a direction 180 degrees opposite to the direction indicated by the X-axis arrow in the illustrated orthogonal coordinate system. When simply described as X direction, it refers to a direction parallel to the X axis regardless of whether it is the same as the direction indicated by the illustrated X-axis arrow. The same applies to directions other than X.

### First embodiment

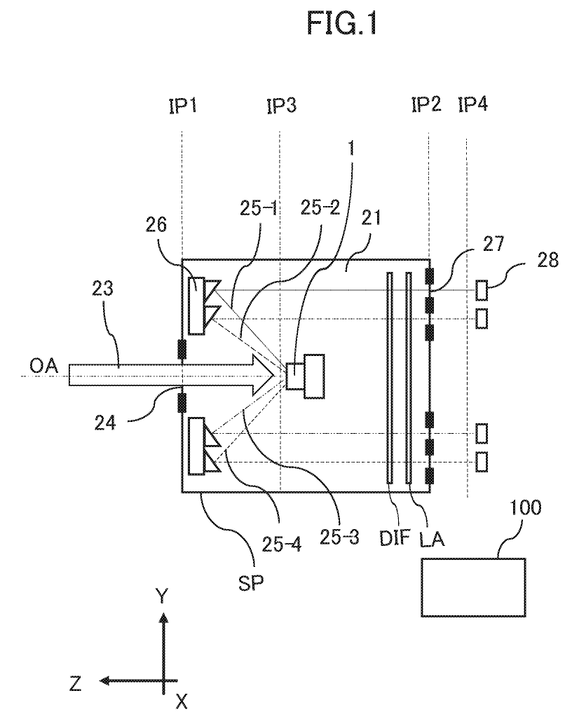

Optical components, optical systems, optical devices, and the like according to the first embodiment will be described. With reference to FIG. 1, an overall configuration of an optical system (integral field spectroscopy system) according to the first embodiment will be described. The integral field spectroscopy system includes an image slicer type integral field spectroscopy unit 21, a two-dimensional photosensor 28 that captures light emitted from the integral field spectroscopy unit 21, and an information processing apparatus 100. The integral field spectroscopy unit 21 includes an incident slit 24 serving as an input portion, a slice mirror 1 serving as a first light receiving portion, a second reflecting surface group 26 serving as a second light receiving portion, and an emission slit array 27.

The photosensor 28 is an imaging device including a two-dimensional light receiving surface having sensitivity in a wavelength band of incident light 23, and transmits detection results (measurement results) at the photosensor 28 to the information processing apparatus 100. The information processing apparatus 100 is a computer that performs information processing related to integral field spectroscopy based on the detection results of the photosensor 28 and calculates two-dimensional spatial information and spectral information about the incident light 23 based on the measurement results of the photosensor 28. When the photosensor 28 captures moving images, the information processing apparatus 100 can also acquire a time dependent change information regarding the two-dimensional spatial information and the spectral information.

The integral field spectroscopy unit 21 serving as an optical device may be used for use in astronomical observation, but can be used for various applications including consumer and industrial applications. When used for astronomical observation, incident light 23 incident from a telescope (not illustrated) is incident on the integral field spectroscopy unit 21 via an incident slit 24 serving as an incident portion, and the incident light 23 travels in the Z minus direction serving as a predetermined direction and reaches the slice mirror 1 (first member). In the drawings referred to in this specification, not limited to FIG. 1, the incident light 23 may be shown as parallel light for convenience of illustration, but the incident light 23 is not necessarily limited to parallel light. An optical axis of an incident optical system (not illustrated) that makes the incident light 23 incident is referred to as an optical axis OA. The incident slit 24 may be an aperture or may be a filter (window) that transmits light in a wavelength range to be observed. As will be described later, a positional relationship between the incident slit 24 and the slice mirror is set such that the incident light 23 that has passed through the incident slit 24 irradiates a region slightly wider than a region where division mirrors of the slice mirror 1 are arranged.

For convenience of explaining positional relationships of respective members, FIG. 1 illustrates a first virtual plane IP1, a second virtual plane IP2, a third virtual plane IP3, and a fourth virtual plane IP4. The first virtual plane IP1, the second virtual plane IP2, and the third virtual plane IP3 are virtual planes perpendicular to the optical axis OA of the incident light 23 and intersecting the support SP and are arranged in order of the first virtual plane IP1, the third virtual plane IP3, and the second virtual plane IP2 from the left side to the right side in the drawing. That is, the first virtual plane IP1, the third virtual plane IP3, and the second virtual plane IP2 are arranged in this order along an incident direction (Z minus direction) of the incident light 23.

The slice mirror 1 has a first reflecting surface group. Normal directions of a plurality of reflecting surfaces constituting the first reflecting surface group are mutually different directions and are also different from a direction of the optical axis OA (optical axis direction). An image at the focal plane of the telescope is divided into a plurality of partial images by the slice mirror 1 serving as an optical element, and light beams of the respective partial images are reflected in different directions. For convenience of illustration, only four reflected light rays, namely, reflected light 25-1, reflected light 25-2, reflected light 25-3, and reflected light 25-4, are schematically shown in FIG. 1. However, the slice mirror 1 is configured to divide the incident light 23 into a larger number of partial images, and a number of mirrors corresponding to the number of divisions is arranged in the second reflecting surface group 26.

A mirror array has the second reflecting surface group 26. Normal directions of a plurality of reflecting surfaces constituting the second reflecting surface group 26 are mutually different directions and are also different from the direction of the optical axis OA (optical axis direction). Reflected light rays (reflected light beams) corresponding to the respective partial images are reflected by the respective mirror surfaces constituting the second reflecting surface group 26, pass through the emission slit array 27, and further, light that has passed through the fourth virtual plane IP4 is guided to the photosensor 28. Each mirror of the second reflecting surface group 26 collimates in the Z minus direction each light beam reflected by the slice mirror 1, and the mirror surface may be a curved surface or a flat surface. The emission slit array 27 can be arranged, for example, in a housing of the integral field spectroscopy unit 21, a support member that supports the slice mirror 1, or a structural member arranged within the integral field spectroscopy unit 21. The fourth virtual plane IP4 may be a surface parallel to a light receiving surface of the photosensor 28. In addition, the fourth virtual plane IP4 may be perpendicular to the optical axis OA. Here, a configuration in which the fourth virtual plane IP4 is perpendicular to the optical axis OA and is parallel to the second virtual plane IP2 has been described, but a bending optical system may be provided between the second virtual plane IP2 and the photosensor 28. In that case, the fourth virtual plane IP4 need not be perpendicular to the optical axis OA, and the second virtual plane IP2 and the fourth virtual plane IP4 may intersect.

The slice mirror 1 including the first reflecting surface group serving as the first light receiving portion is positioned between the third virtual plane IP3 and the second virtual plane IP2, and the second reflecting surface group 26 serving as the second light receiving portion is positioned between the first virtual plane IP1 and the third virtual plane IP3. Light incident through the first virtual plane IP1 is reflected by the first reflecting surface group of the slice mirror 1 in a plurality of different directions non-parallel to the optical axis OA, and the second reflecting surface group 26 reflects the light reflected by the first reflecting surface group. Light reflected by the second reflecting surface group 26 is emitted through the second virtual plane IP2. In this manner, at least a part (50% or more, in some case 75% or more, and in other case 90% or more) of light incident on the first reflecting surface group is emitted through the second virtual plane IP2.

Between the second reflecting surface group 26 and the photosensor 28, a diffraction grating DIF serving as a spectroscopic portion can be arranged for spectrally dispersing light beams of the respective partial images according to wavelength. In addition, between the diffraction grating DIF and the photosensor 28, a condensing lens LA (lens array) can be arranged to condense the partial images spectrally dispersed according to wavelength by the diffraction grating onto the light receiving surface of the photosensor 28.

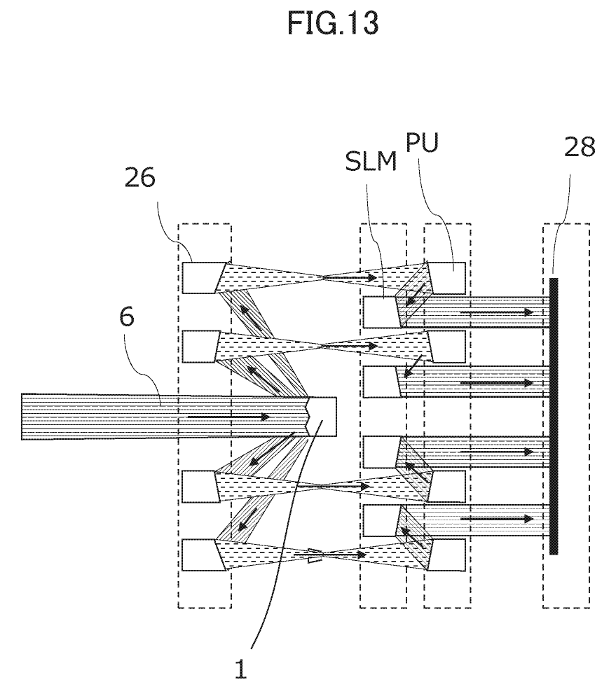

As shown in FIG. 13, a pupil mirror PU and a slit mirror SLM may be arranged between the slice mirror 1 and the photosensor 28. The pupil mirror PU is a mirror for rearranging images divided by the slice mirror 1. The slit mirror SLM is a mirror for emitting the optical images rearranged by the pupil mirror PU in a slit shape toward the photosensor 28.

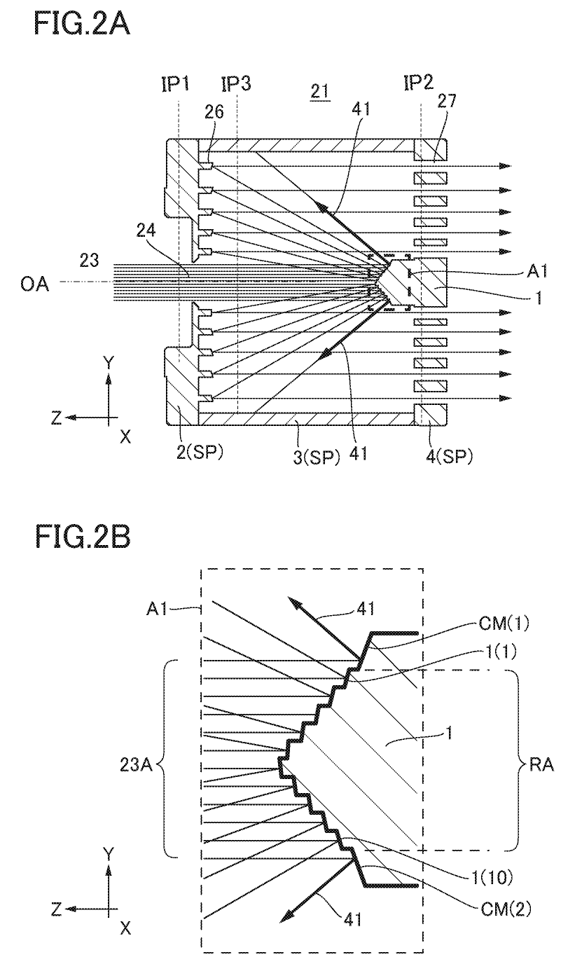

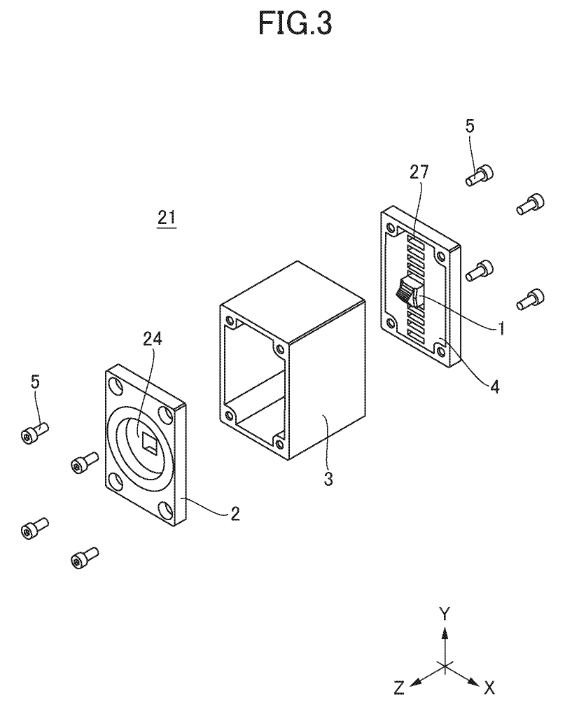

FIG. 2A is a schematic cross-sectional view of the integral field spectroscopy unit 21 according to the embodiment taken along the YZ plane. FIG. 2B is an enlarged view of a portion surrounded by a dotted line A1 in FIG. 2A, that is, a partially enlarged cross-sectional view of the slice mirror 1 (optical component). FIG. 3 is an exploded perspective view for explaining a structure of the integral field spectroscopy unit.

As shown in FIG. 3, the integral field spectroscopy unit 21 is composed of an incident side member 2, an intermediate member 3, an emission side member 4, and bolts 5 for fastening and integrating them. The incident side member 2 and the intermediate member 3, and the intermediate member 3 and the emission side member 4 may be connected to each other by other fixing means such as an adhesive instead of the bolts 5.

The incident side member 2 has an incident slit 24 serving as an incident portion and a second light receiving portion including the second reflecting surface group 26 and supports the second reflecting surface group 26. The intermediate member 3 is arranged between the incident side member 2 and the emission side member 4 and supports the incident side member 2 and the emission side member 4 so as to be fixed in a predetermined positional relationship. The emission side member 4 has the slice mirror 1 (optical component) and the emission slit array 27 and supports the first reflecting surface group of the slice mirror 1. Therefore, the incident side member 2, the intermediate member 3, and the emission side member 4 can function as a support SP (supporter) that supports the first light receiving portion and the second light receiving portion. The first virtual plane IP1 intersects the incident side member 2, the second virtual plane IP2 intersects the emission side member 4, and the third virtual plane IP3 intersects the intermediate member 3.

Since optical elements and optical components included in the integral field spectroscopy unit 21 are consolidated in the incident side member 2 and the emission side member 4 and are integrated via the intermediate member 3 serving as the support SP, relative positions of the optical elements and optical components are positioned with high accuracy. The incident side member 2, the intermediate member 3, and the emission side member 4 constitute a support SP that supports the slice mirror 1 and the second reflecting surface group 26. An exterior portion of the incident side member 2 to the emission side member 4 can also function as a light-shielding member (cover) that shields external light that attempts to enter an optical path space within the integral field spectroscopy unit 21.

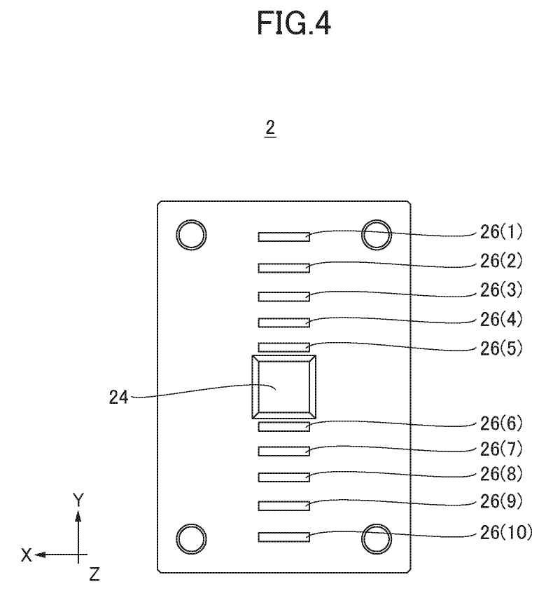

FIG. 4 is a plan view of the incident side member 2 as viewed along the Z plus direction from the emission side member 4 side (that is, the slice mirror 1 side). The incident side member 2 is provided with the incident slit 24 and the second reflecting surface group 26 shown in FIG. 1. The second reflecting surface group 26 is schematically illustrated as a mirror array consisting of ten individual mirrors in FIG. 4. Individual mirrors 26(1) to 26(10) are arranged at positions where reflected light from individual division mirrors constituting the slice mirror 1 arrives. The number and positions of the individual mirrors can be set according to the number and reflecting surface orientations of the individual division mirrors constituting the slice mirror 1.

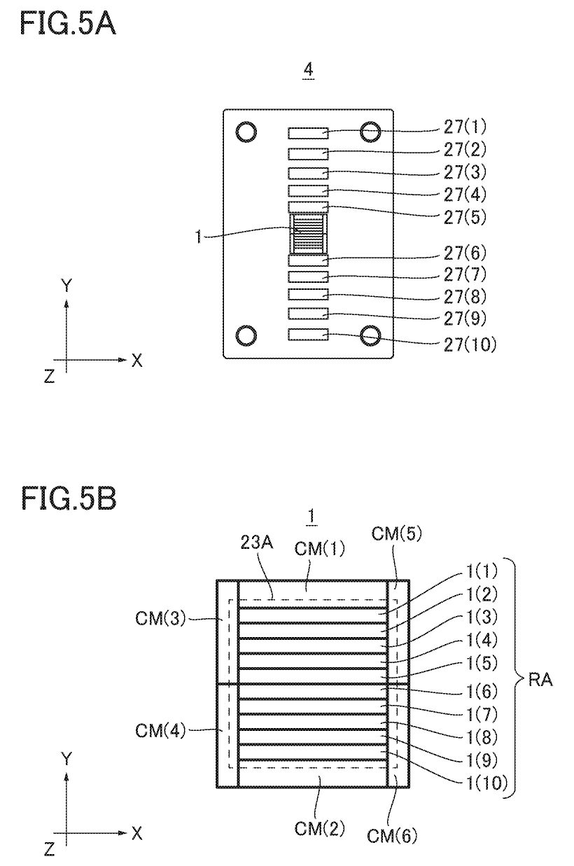

FIG. 5A is a plan view of the emission side member 4 as viewed along the Z minus direction from the incident side member 2 side (that is, the incident slit 24 side). The emission side member 4 is provided with the slice mirror 1 and the emission slit array 27 shown in FIG. 1.

The emission slit array 27 is illustrated as a slit array consisting of ten individual slits in FIG. 5A. Individual slits 27(1) to 27(10) are arranged so as to individually transmit ten light beams reflected and collimated by the second reflecting surface group 26. The number and positions of the individual slits can be set according to the number and reflecting surface orientations of the individual division mirrors constituting the slice mirror 1, in other words, according to the number and positions of the individual mirrors constituting the second reflecting surface group 26.

FIG. 5B is an enlarged plan view showing the slice mirror 1 described in FIG. 5A in an enlarged manner. The slice mirror 1 includes ten division mirrors 1(1) to 1(10) for reflecting incident light 23 (observation light) incident through the incident slit 24 in mutually different directions as divided ten light beams. The slice mirror 1 is configured such that the ten light beams reflected by the division mirrors 1(1) to 1(10) irradiate individual mirrors 26(1) to 26(10) of the second reflecting surface group 26.

In integral field spectroscopy, since it is desirable that observation light be evenly divided by the slice mirror, reflecting surfaces of the division mirrors 1(1) to 1(10) can be configured to have equal areas and shapes. In addition, it is desirable to configure such that even a reflecting surface arranged at an outermost side of the slice mirror is configured so that an entire area of the reflecting surface can be irradiated with observation light without deficiency. Theoretically, it is sufficient to configure such that an outer edge of the reflecting surface arranged at the outermost side and an outer edge of an irradiation region of the observation light strictly coincide in position, but considering mechanical assembly accuracy and positional deviation over time, this is not realistic. Therefore, in order to enable the reflecting surface arranged at the outermost side of the slice mirror to be entirely irradiated with observation light without deficiency, an irradiation region of the observation light can be set slightly wider than a reflecting region of the slice mirror (an entire region in which a plurality of reflecting surfaces are provided). In addition, in order to enable observation light to be irradiated over an entire area of each reflecting surface of the division mirrors 1(1) to 1(10), a position and an opening shape of the incident slit 24 are set such that the incident light 23 can irradiate a first light receiving portion 23A (shown surrounded by a dotted line) slightly wider than a region where the division mirrors are arranged.

For convenience of explanation, as shown in FIGS. 2B and 5B, a region where the division mirrors 1(1) to 1(10) are arranged in the first light receiving portion 23A is referred to as a first reflecting surface group RA. In addition, a peripheral region outside a region where the division mirrors are arranged in the first light receiving portion 23A is referred to as a peripheral portion of the first reflecting surface group RA or a “specific incident surface”. This specific incident surface is a region separate from the reflecting surfaces of the first reflecting surface group RA of the first light receiving portion 23A. In order to spectrally disperse the incident light 23 with as little loss as possible and to ensure spectroscopic accuracy, it may be that the first reflecting surface group RA be reliably irradiated with the incident light 23 and that the incident light 23 irradiating the specific incident surface of the peripheral portion of the first reflecting surface group RA be small. Therefore, when viewed along the Z direction which is the optical axis direction of the incident light 23, for example, the position and opening shape of the incident slit 24 may be set such that an area of the first light receiving portion 23A exceeds 1.0 times and is equal to or less than 1.3 times an area of the first reflecting surface group RA.

When observation light is irradiated even outside the reflecting region of the slice mirror, it becomes stray light reflected by a member outside the reflecting region whose traveling direction is not controlled, and there is a possibility of reaching the photosensor via an unplanned optical path. Stray light incident on the photosensor becomes observation noise and reduces spatial or frequency-related resolution in integral field spectroscopy, which is undesirable. The incident light 23 irradiating the peripheral portion of the first reflecting surface group RA is naturally not reflected by the division mirrors 1(1) to 1(10). When the incident light 23 irradiating the peripheral portion of the first reflecting surface group RA becomes stray light and is incident on the individual mirrors of the second reflecting surface group 26, there is a possibility that stray light is guided to the photosensor 28. In addition, when stray light from the peripheral portion of the first reflecting surface group RA is incident on the emission slit array 27, there is a possibility that stray light is guided to the photosensor 28. When a light beam reflected by the first reflecting surface group RA and stray light become superimposed on a light receiving surface of the photosensor 28, a noise component due to the stray light is superimposed on detection results of the photosensor 28, and spatial or frequency spectroscopic accuracy decreases. Therefore, among the incident light 23 incident on the specific incident surface separate from the first reflecting surface group RA in the first light receiving portion 23A, light emitted through the second virtual plane IP2 can be regarded as unnecessary light. The presence of unnecessary light degrades optical characteristics. Therefore, the optical device of the present embodiment has a structure in which at least a part (50% or more, in some case 75% or more, and in other case 90% or more) of light incident on the specific incident surface separate from the first reflecting surface group RA is not emitted through the second virtual plane IP2. By doing so, unnecessary light is reduced.

Therefore, in the present embodiment, a stray light suppression means (stray light suppression portion) for suppressing light incident on the peripheral portion of the first reflecting surface group RA from becoming stray light is provided. In the example of FIG. 5B, light control mirrors CM(1) to CM(6) are arranged around a region where the division mirrors 1(1) to 1(10) are provided (that is, the first reflecting surface group RA). The light control mirrors CM(1) to CM(6) are mirrors that reflect light incident on the peripheral portion of the first reflecting surface group RA in a direction not toward individual mirrors of the second reflecting surface group 26 (a direction where individual mirrors are not arranged). On the specific incident surface that can be a cause of the above-described unnecessary light, these light control mirrors CM(1) to CM(6) are provided. Normal directions of respective reflecting surfaces of the light control mirror CM(1) to CM(6) are mutually different, are also different from a direction of the optical axis OA (optical axis direction), and can be different from normal directions of reflecting surfaces of the first reflecting surface group RA. In the illustrated example, six light control mirrors are arranged, but the number of light control mirrors is not limited to six as long as the incident light 23 irradiating the peripheral portion of the first reflecting surface group RA can be reflected in a direction not toward the individual mirrors of the second reflecting surface group 26. In addition, a shape of each light control mirror is not limited to a rectangle. The light control mirrors can also be referred to as stray light suppression mirrors.

As shown in FIGS. 2A and 2B, most of light incident on the first light receiving portion 23A via the incident slit 24, that is, light incident on the first reflecting surface group RA, is reflected toward the individual mirrors 26(1) to 26(10) of the second reflecting surface group 26 by the division mirrors 1(1) to 1(10). On the other hand, light incident on the peripheral portion (specific incident surface) of the first reflecting surface group RA is reflected as peripheral portion reflected light 41 in a predetermined direction different from the individual mirrors of the second reflecting surface group 26 by the light control mirror CM(1) and the light control mirror CM(2) in the example of FIG. 2B showing a YZ cross section. Although not illustrated for an XZ cross section, light incident on the peripheral portion of the first reflecting surface group RA is reflected by any of the light control mirrors CM(3) to CM(6) in a predetermined direction different from the individual mirrors of the second reflecting surface group 26.

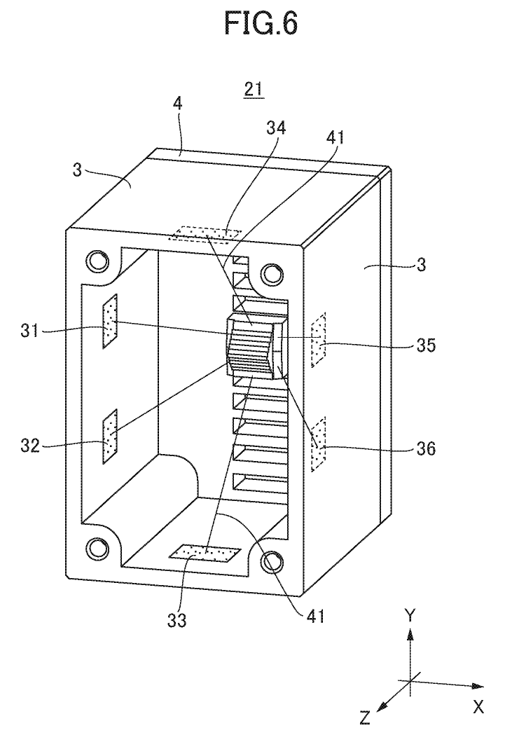

FIG. 6 is a perspective view in which the incident side member 2 is removed from the integral field spectroscopy unit 21 to make an inner surface of the intermediate member 3 easily visible, in order to explain an optical path of peripheral portion reflected light reflected in a predetermined direction different from the second reflecting surface group 26 by the light control mirrors. Peripheral portion reflected light reflected in the predetermined direction by the light control mirrors is incident on specific regions 31 to 36 of an inner surface of the intermediate member 3. The specific regions 34 to 36 are schematically illustrated with dotted lines to indicate that they are regions on an inner surface side of the intermediate member 3. It may be that the specific regions 31 to 36 be provided in a portion of the support SP positioned between the second virtual plane IP2 and the third virtual plane IP3. That is, the optical device has a structure in which at least a part of light incident on the specific incident surface (light control mirror CM) is reflected by the specific incident surface (light control mirror CM) and is incident on a portion of the support SP positioned between the second virtual plane IP2 and the third virtual plane IP3. To realize this, it may adopt a structure in which normals to the specific incident surface (light control mirror) intersect a portion of the support SP positioned between the second virtual plane IP2 and the third virtual plane IP3 (in this example, a part of the intermediate member 3). A normal direction to the specific incident surface (light control mirror) is a direction representing an orientation of the specific incident surface, and is a direction characterizing an incident direction to the specific incident surface and a reflection direction at the specific incident surface. By guiding reflected light from the specific incident surface to a portion of the support SP positioned between the second virtual plane IP2 and the third virtual plane IP3 (specific regions 31 to 36), direct incidence of reflected light from the specific incident surface on the second reflecting surface group 26 can be suppressed, and thereby unnecessary light emitted from the second virtual plane IP2 among light incident on the specific incident surface can be reduced.

As a first method for further suppressing peripheral portion reflected light incident on the specific regions 31 to 36 from becoming stray light and being reflected in a direction of the second reflecting surface group 26 or the emission slit array 27, antireflection treatment (providing an antireflection structure) is applied to these specific regions 31 to 36. The treatment method is not particularly limited as long as it can suppress light in a wavelength region included in peripheral portion reflected light from being reflected in a direction of the second reflecting surface group 26 or the emission slit array 27. For example, regarding the specific regions 31 to 36 of an inner surface of the intermediate member 3, rough surface processing is applied to form a light scattering surface or a diffuse reflection surface, an antireflection film is formed, an antireflection member is attached, and the like can be mentioned. In addition to a rough surface where geometrical optics is dominant such as diffuse reflection, a structure where wave optics is dominant that cancels light (absorbs light) using light interference can also be adopted by providing an uneven structure having height differences and pitches equal to or less than a wavelength of incident light on the specific regions 31 to 36. Such a fine uneven structure can be realized by laser surface processing. If a structure that absorbs light is provided on the specific regions 31 to 36, generation of unnecessary light can be reduced.

As a method for performing rough surface processing on an inner surface of the intermediate member 3, for example, blast processing, etching processing, laser surface processing, and the like can be mentioned. By forming a diffuse reflection surface or a light scattering surface by these methods, intensity of light reflected in a direction of the second reflecting surface group 26 or the emission slit array 27 can be significantly reduced. As a method for forming an antireflection film on an inner surface of the intermediate member 3, a method of forming a film of a low reflection material by, for example, coating, vapor deposition, printing, and the like can be mentioned. By forming an antireflection film, intensity of light reflected in a direction of the second reflecting surface group 26 or the emission slit array 27 can be significantly reduced. As a method for attaching an antireflection member, for example, a method of adhering an optical mask or filter can be mentioned. By attaching an antireflection member, intensity of light reflected in a direction of the second reflecting surface group 26 or the emission slit array 27 can be significantly reduced.

As a second method for further suppressing peripheral portion reflected light incident on the specific regions 31 to 36 from becoming stray light and being reflected in a direction of the second reflecting surface group 26 or the emission slit array 27, light transmission windows (apertures or windows made of light transmitting material) may be arranged in these regions. That is, peripheral portion reflected light incident on the specific regions 31 to 36 may be guided outside the integral field spectroscopy unit 21.

As a third method for further suppressing peripheral portion reflected light incident on the specific regions 31 to 36 from becoming stray light, mirrors may be provided in these regions to specularly reflect peripheral portion reflected light in a direction where the second reflecting surface group 26 and the emission slit array 27 are not arranged. The antireflection treatment of the first method described above may be applied to an arrival position of specularly reflected peripheral portion reflected light, or an aperture or a window made of light transmitting material of the second method may be arranged to guide peripheral portion reflected light outside the integral field spectroscopy unit 21. Alternatively, mirrors may be further arranged at an arrival position of specularly reflected peripheral portion reflected light, and peripheral portion reflected light may be multiply reflected to be guided in a direction where the second reflecting surface group 26 and the emission slit array 27 are not arranged.

As described above, according to the present embodiment, it is possible to provide a technique advantageous for utilizing most of light incident on an image slicer type optical device by reflecting it with division mirrors and suppressing generation of stray light. That is, it is possible to provide optical components, optical systems, and optical devices for achieving high spectroscopic accuracy.

### Second Embodiment

Optical components, optical systems, optical devices, and the like according to the second embodiment will be described. Description of matters similar to the first embodiment will be simplified or omitted. In the optical device according to the first embodiment, light control mirrors were arranged around the first reflecting surface group RA of the slice mirror 1. Light incident on the peripheral portion of the first reflecting surface group RA was specularly reflected by the light control mirrors and guided in a predetermined direction different from a direction of individual mirrors of the second reflecting surface group 26 or the emission slit array 27.

In contrast, in the second embodiment, antireflection treatment is applied to a position where the light control mirrors were arranged in the first embodiment, that is, the peripheral portion of the first reflecting surface group RA of the slice mirror 1. Also in the second embodiment, when viewed along the Z direction which is the optical axis direction of the incident light 23, for example, the position and opening shape of the incident slit 24 may be set such that an area of the first light receiving portion 23A exceeds 1.0 times and is equal to or less than 1.3 times an area of the first reflecting surface group RA.

In the present embodiment, by applying treatment that suppresses reflection to the peripheral portion of the first reflecting surface group RA, light incident on this portion is suppressed from becoming stray light and being reflected in a direction of the second reflecting surface group 26 or the emission slit array 27. The treatment method is not particularly limited as long as it can suppress light in a wavelength region included in light incident on the peripheral portion of the first reflecting surface group RA from being reflected in a direction of the second reflecting surface group 26 or the emission slit array 27. For example, regarding the peripheral portion of the first reflecting surface group RA of the slice mirror 1, rough surface processing is applied, an antireflection film is formed, an antireflection member is attached, and the like can be mentioned.

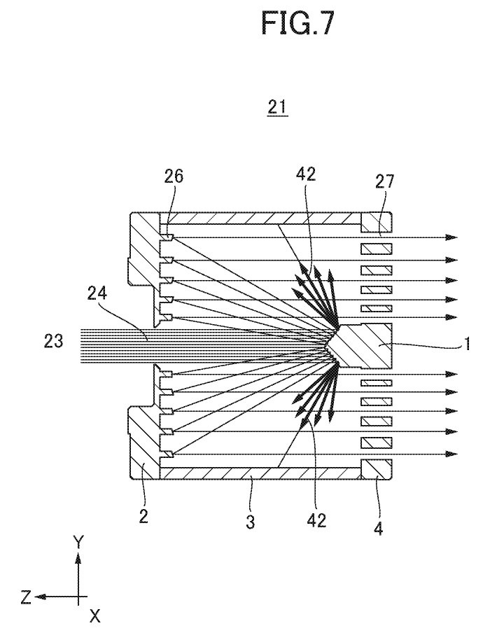

FIG. 7 is a schematic cross-sectional view showing the integral field spectroscopy unit 21 in which rough surface processing is applied to the peripheral portion of the first reflecting surface group RA of the slice mirror 1 as an example of the second embodiment. FIG. 7 for explaining the second embodiment corresponds to FIG. 2A in the description of the first embodiment.

Since a surface of a reflecting material is subjected to rough surface processing at the peripheral portion of the first reflecting surface group RA of the slice mirror 1 and a diffuse reflection surface is formed, the incident light 23 incident on this portion is dispersed and reflected in multiple directions as diffusely reflected light 42. Therefore, intensity of light reflected in a direction of the second reflecting surface group 26 or the emission slit array 27 can be significantly reduced. As a method for performing rough surface processing on the peripheral portion of the first reflecting surface group RA of the slice mirror 1, for example, blast processing, etching processing, laser surface processing, and the like can be mentioned.

When a base surface of a reflecting material is subjected to rough surface processing, orientations of diffusely reflected light reflected by the rough surface spread and are distributed around a specular reflection direction with respect to the base surface. Therefore, regarding the peripheral portion of the first reflecting surface group RA subjected to rough surface processing, it may be set a specular reflection direction of a base surface before rough surface processing to a direction where the second reflecting surface group 26 and the emission slit array 27 are not arranged.

As a method for forming an antireflection film on the peripheral portion of the first reflecting surface group RA of the slice mirror 1, a method of forming a film of a low reflection material by, for example, coating, vapor deposition, printing, and the like can be mentioned. By forming an antireflection film, intensity of light reflected in a direction of the second reflecting surface group 26 or the emission slit array 27 can be significantly reduced. Regarding the peripheral portion of the first reflecting surface group RA where an antireflection film is formed, it may be set a specular reflection direction of a base surface before forming the antireflection film to a direction where the second reflecting surface group 26 and the emission slit array 27 are not arranged.

As a method for attaching an antireflection member to the peripheral portion of the first reflecting surface group RA of the slice mirror 1, for example, a method of adhering an optical mask, filter, antireflection film, light absorption film, or the like can be mentioned. By attaching an antireflection member, intensity of light reflected in a direction of the second reflecting surface group 26 or the emission slit array 27 can be reduced. It may be set a specular reflection direction of a base surface before attaching an antireflection member to a direction where the second reflecting surface group 26 and the emission slit array 27 are not arranged. In addition to a rough surface where geometrical optics is dominant such as diffuse reflection, a structure where wave optics is dominant that cancels light (absorbs light) using light interference can also be adopted by providing an uneven structure having height differences and/or pitches equal to or less than a wavelength of incident light on the specific incident surface. Such a fine uneven structure can be realized by laser surface processing. If a structure that absorbs light is provided on the specific incident surface, generation of stray light can be reduced.

According to the present embodiment, it is possible to provide a technique advantageous for utilizing most of light incident on an image slicer type optical device by reflecting it with division mirrors and suppressing generation of stray light. That is, it is possible to provide optical components, optical systems, and optical devices for achieving high spectroscopic accuracy.

### Third Embodiment

Optical components, optical systems, optical devices, and the like according to the third embodiment will be described. Description of matters similar to the first embodiment or the second embodiment will be simplified or omitted. In the first embodiment and the second embodiment, the peripheral portion of the first reflecting surface group RA of the slice mirror 1 included in the emission side member 4 was processed to suppress light reflected at this portion from becoming stray light and being incident on individual mirrors of the second reflecting surface group 26 or the emission slit array 27.

In contrast, an emission side member 4A according to the third embodiment is provided with a mask member 6 that masks the peripheral portion of the first reflecting surface group RA of the slice mirror 1 on an incident slit 24 side relative to the peripheral portion of the first reflecting surface group RA of the slice mirror 1 in an optical axis direction (Z direction) of the incident light 23. Also in the third embodiment, when viewed along the Z direction which is the optical axis direction of the incident light 23, for example, the position and opening shape of the incident slit 24 may be set such that an area of the first light receiving portion 23A exceeds 1.0 times and is equal to or less than 1.3 times an area of the first reflecting surface group RA.

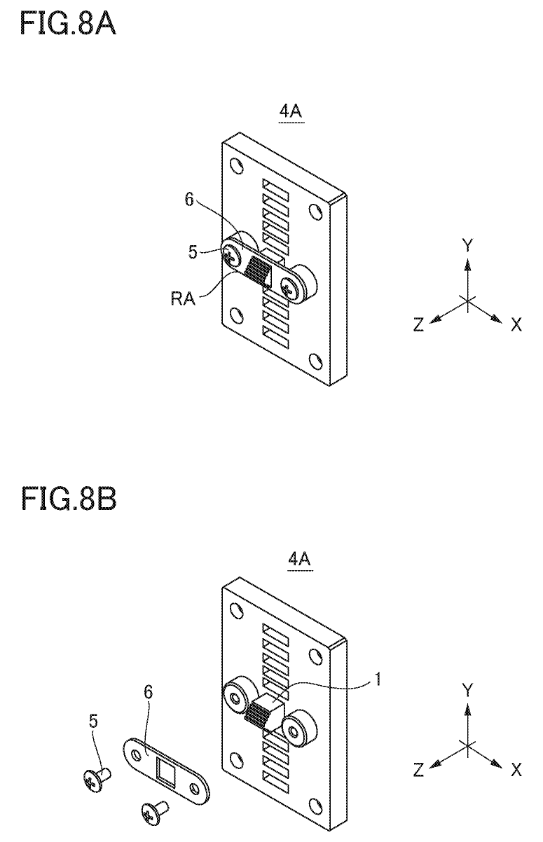

FIG. 8A is a perspective view showing an appearance of the emission side member 4A according to the third embodiment, and FIG. 8B is an exploded perspective view of the emission side member 4A according to the third embodiment. As shown in FIG. 8B, the mask member 6 is fastened by bolts 5 and fixed to the emission side member 4A. However, the mask member 6 may be fixed to the emission side member 4A by other means such as an adhesive. The mask member 6 is provided with an opening for exposing the first reflecting surface group RA of the slice mirror 1 to the incident slit 24 side.

In an assembled state as shown in FIG. 8A, the first reflecting surface group RA of the slice mirror 1 protrudes in the Z plus direction toward the incident slit 24 side from an opening of the mask member 6, and the peripheral portion of the first reflecting surface group RA of the slice mirror 1 is masked by the mask member 6.

Also in the present embodiment, the first light receiving portion 23A is set larger than the first reflecting surface group RA, but the incident light 23 incident on the peripheral portion of the first reflecting surface group RA is irradiated onto the mask member 6, and is suppressed from being reflected in a direction of the second reflecting surface group 26 or the emission slit array 27 by an action of the mask member 6. The mask member 6 is a member having a function of suppressing the incident light 23 from being reflected in a direction of the second reflecting surface group 26, and can be, for example, an optical filter or a light shielding plate. In the first embodiment or the second embodiment, there was a possibility of damaging mirror surfaces of division mirrors when processing the peripheral portion of the first reflecting surface group RA of the slice mirror 1, but in the present embodiment, the mask member 6 is manufactured separately from the slice mirror 1. Therefore, the emission side member 4 including the slice mirror 1 can be manufactured with high manufacturing yield.

According to the present embodiment, it is possible to provide a technique advantageous for utilizing most of light incident on an image slicer type optical device by reflecting it with division mirrors and suppressing generation of stray light. That is, it is possible to provide optical components, optical systems, and optical devices for achieving high spectroscopic accuracy.

### Fourth Embodiment

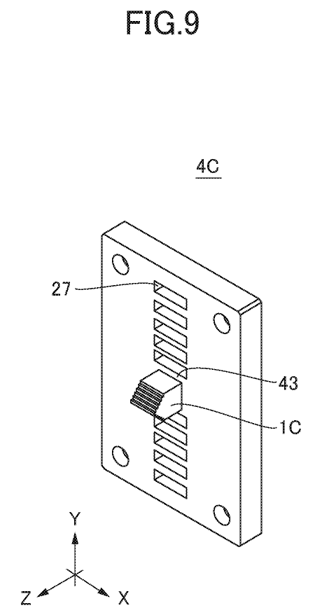

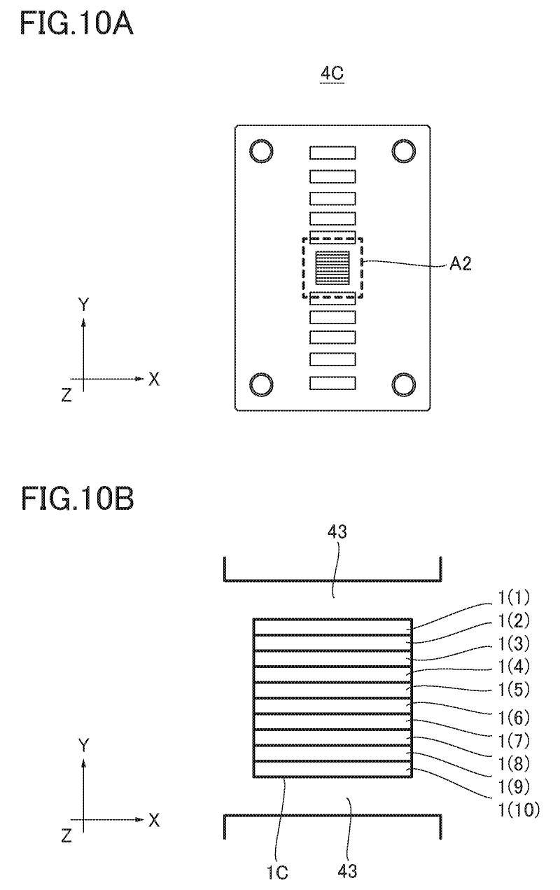

FIG. 9 shows a perspective view of an emission side member 4C according to the fourth embodiment, and FIG. 10A shows a front view of the emission side member 4C according to the fourth embodiment. FIG. 10B shows an enlarged view of a region A2 surrounded by a dotted line in FIG. 10A. FIG. 10B can also be said to show an irradiation region irradiated with incident light via the incident slit 24 in an enlarged manner.

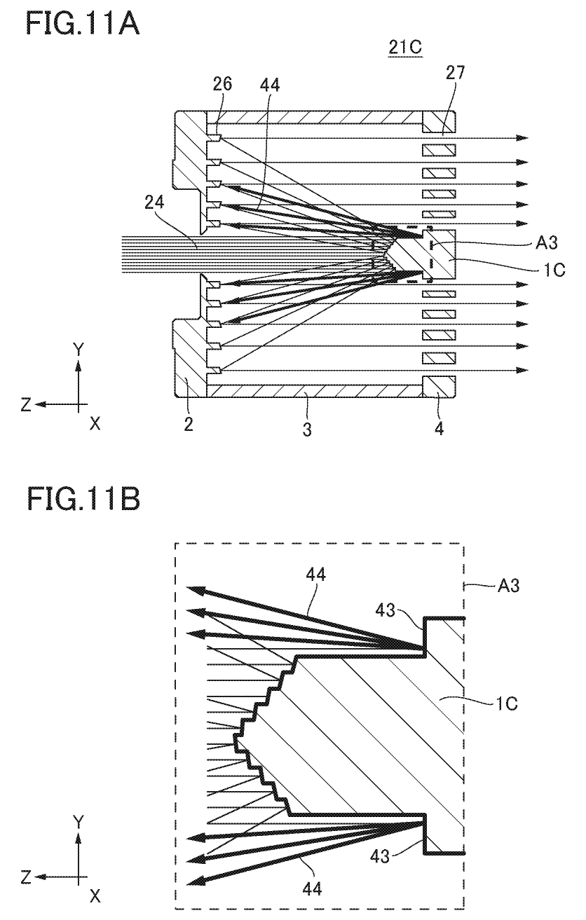

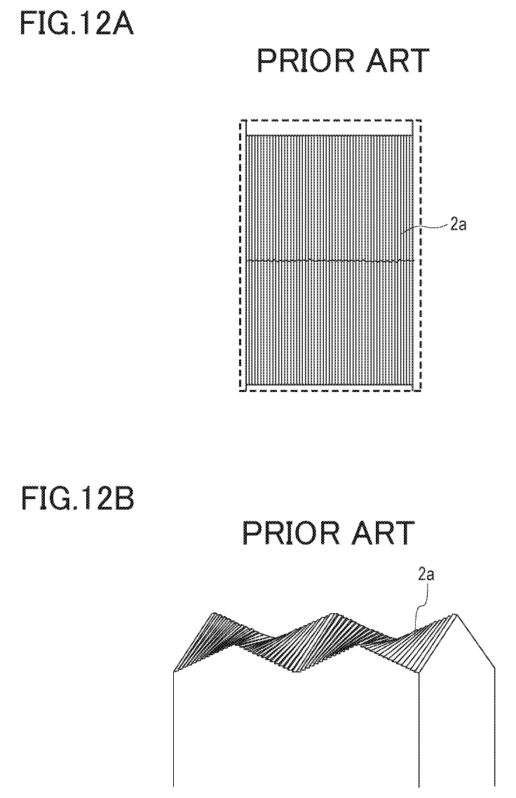

FIG. 11A is a schematic cross-sectional view of the integral field spectroscopy unit 21C according to the fourth embodiment taken along the YZ plane. FIG. 11B is an enlarged view of a portion A3 surrounded by a dotted line in FIG. 11A. That is, FIG. 11B is a partially enlarged cross-sectional view of the slice mirror 1C according to the fourth embodiment. Also in the fourth embodiment, incident light is irradiated onto an irradiation region wider than a division reflection region. Thereby, the division reflection region can be effectively utilized.

In the fourth embodiment, a peripheral portion of a division reflection region of the slice mirror 1C is configured as a structural portion 43 for mechanically supporting the division reflection region where division mirrors are arranged. In addition, an orientation and a shape of a surface of the structural portion 43 are composed of surfaces perpendicular to the optical axis and surfaces parallel to the optical axis. Therefore, incident light incident on the peripheral portion of the division reflection region is reflected by a surface perpendicular to the optical axis of the structural portion 43 made of a reflecting material. A surface perpendicular to the optical axis in the structural portion 43 becomes a specific incident surface. A small portion of reflected light 44 incident parallel to the optical axis on the specific incident surface and reflected by the structural portion 43 can be emitted from the incident slit 24. However, a large portion of reflected light 44 reflected by the structural portion 43 can become stray light that reaches a position where the second reflecting surface group 26 is arranged with relatively strong intensity. Alternatively, the reflected light 44 can become stray light and reach the emission slit array 27. A surface of a structural portion for mechanically supporting the slice mirror 1C is not limited to a surface parallel to an XY plane. For example, side surfaces of a root of the slice mirror 1C (surfaces parallel to an XZ plane or a YZ plane) are also included, and light that is diffusely reflected multiple times via these surfaces can also become stray light that reaches the second reflecting surface group 26 or the emission slit array 27.

As described above, in the integral field spectroscopy unit 21C according to the fourth embodiment, a configuration of the peripheral portion of the first reflecting surface group RA is different from the first to third embodiments. Therefore, when division mirrors 1(1) to 1(10) having the same shape as those of the above-described embodiments are provided on the slice mirror 1C of the fourth embodiment, intensity of stray light reaching the photosensor via the second reflecting surface group 26 was much larger than in the first to third embodiments. Therefore, in an optical device using the emission side member 4C according to the fourth embodiment, spectroscopic accuracy as high as in the first to third embodiments could not be achieved.

### Modifications

The present disclosure is not limited to the embodiments described above, and many variations are possible within the technical concept of the present disclosure. For example, all or some of the different embodiments described above may be combined for implementation.

For example, the light control mirrors CM(1) to CM(6) shown in the first embodiment may be configured as a mask member 6 as in the third embodiment. Alternatively, treatment applied to the peripheral portion of the first reflecting surface group RA of the slice mirror 1 in the second embodiment may be applied to the mask member 6 shown in the third embodiment.

Furthermore, the contents of disclosure in the present specification include not only contents described in the present specification but also all of the items which are understandable from the present specification and the drawings accompanying the present specification. Moreover, the contents of disclosure in the present specification include a complementary set of concepts described in the present specification. Thus, if, in the present specification, there is a description indicating that, for example, "A is B", even when a description indicating that "A is not B" is omitted, the present specification can be said to disclose a description indicating that "A is not B". This is because, in a case where there is a description indicating that "A is B", taking into consideration a case where "A is not B" is a premise.

### Other Embodiments

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-031411, filed Feb. 28, 2025, which is hereby incorporated by reference herein in its entirety.

What is claimed is:

1. An optical device comprising:
a first light receiving portion having a first reflecting surface group;
a second light receiving portion having a second reflecting surface group; and
a support that supports the first light receiving portion and the second light receiving portion,
wherein, with respect to a first virtual plane perpendicular to an optical axis of the optical device and intersecting the support, a second virtual plane perpendicular to the optical axis and intersecting the support, and a third virtual plane perpendicular to the optical axis and between the first virtual plane and the second virtual plane, the first light receiving portion is positioned between the third virtual plane and the second virtual plane, and the second light receiving portion is positioned between the first virtual plane and the third virtual plane,
wherein the first reflecting surface group is configured to reflect light incident through the first virtual plane in a plurality of different directions non-parallel to the optical axis, the second reflecting surface group is configured to reflect the light reflected by the first reflecting surface group, and the light reflected by the second reflecting surface group is emitted through the second virtual plane, and
wherein the first light receiving portion has, separately from the first reflecting surface group, an incident surface on which light incident through the first virtual plane is incident, and the first light receiving portion has a structure configured such that at least a part of light incident on the incident surface is not emitted through the second virtual plane.

2. An optical device comprising:
a first light receiving portion having a first reflecting surface group;
a second light receiving portion having a second reflecting surface group; and
a support that supports the first light receiving portion and the second light receiving portion,
wherein, with respect to a first virtual plane perpendicular to an optical axis of the optical device and intersecting the support, a second virtual plane perpendicular to the optical axis and intersecting the support, and a third virtual plane perpendicular to the optical axis and between the first virtual plane and the second virtual plane, the first light receiving portion is positioned between the third virtual plane and the second virtual plane, and the second light receiving portion is positioned between the first virtual plane and the third virtual plane,
wherein the first reflecting surface group is configured to reflect light incident through the first virtual plane in a plurality of different directions non-parallel to the optical axis, the second reflecting surface group is configured to reflect the light reflected by the first reflecting surface group, and the light reflected by the second reflecting surface group is emitted through the second virtual plane, and
wherein the first light receiving portion has, separately from the first reflecting surface group, an incident surface on which light incident through the first virtual plane is incident, and has a structure configured such that at least a part of the light incident on the incident surface is reflected at the incident surface and is incident on a portion of the support located between the second virtual plane and the third virtual plane.

3. The optical device according to claim 2, wherein the second virtual plane is positioned between a fourth virtual plane perpendicular to the optical axis and the third virtual plane, and light that has passed through the second virtual plane passes through the fourth virtual plane.

4. The optical device according to claim 3, further comprising a spectroscopic portion configured to spectrally disperse light that has passed through the third virtual plane between the fourth virtual plane and the second virtual plane.

5. The optical device according to claim 4, wherein the spectroscopic portion is a diffraction grating.

6. The optical device according to claim 2, wherein the incident surface includes a first mirror configured to reflect light irradiated onto the incident surface in a direction not toward the second reflecting surface group included in the second light receiving portion.

7. The optical device according to claim 6, wherein the support includes, at a position irradiated with light irradiated onto the incident surface and reflected by the first mirror, any one of a light scattering surface, an antireflection film, a light transmission window, and a second mirror configured to reflect the light reflected by the first mirror in a direction not toward the second light receiving portion.

8. The optical device according to claim 7, wherein the light transmission window is an aperture provided in the support or a window made of a light transmitting material.

9. The optical device according to claim 2, wherein the first light receiving portion includes at least one of a diffuse reflection surface, an antireflection film, an antireflection member, and a mask member arranged outside the first reflecting surface group.

10. The optical device according to claim 9, wherein the diffuse reflection surface, the antireflection film, or the antireflection member is provided on a structural portion arranged outside the first reflecting surface group.

11. The optical device according to claim 9, wherein the mask member covers a structural portion arranged outside the first reflecting surface group.

12. The optical device according to claim 2, wherein an area of the first light receiving portion exceeds 1.0 times and is equal to or less than 1.3 times an area of the first reflecting surface group.

13. The optical device according to claim 2, wherein a normal to the incident surface intersects the portion of the support located between the second virtual plane and the third virtual plane.

14. The optical device according to claim 2,
wherein the optical device has a structure configured such that 50% or more of the light incident on the first reflecting surface group is emitted through the second virtual plane, and 50% or more of the light incident on the incident surface is not emitted through the second virtual plane.

15. The optical device according to claim 2, wherein the support includes a first member that supports the first light receiving portion, a second member that supports the second light receiving portion, and a third member that fixes the first member and the second member.

16. The optical device according to claim 15, wherein the first virtual plane intersects the second member, the second virtual plane intersects the first member, and the third virtual plane intersects the third member.

17. The optical device according to claim 3, further comprising a slit array configured to transmit each of a plurality of light beams reflected by the second light receiving portion between the fourth virtual plane and the second virtual plane.

18. The optical device according to claim 3, further comprising a pupil mirror configured to arrange a plurality of light beams reflected by the second light receiving portion between the fourth virtual plane and the third virtual plane.

19. An optical system comprising:
the optical device according to claim 3; and
a sensor configured to detect light emitted through the fourth virtual plane.

20. The optical system according to claim 19, further comprising a computer configured to perform information processing related to integral field spectroscopy based on detection results of the sensor.
